(19) United States
(12) Patent Application Publication
(10) Pub. No.: US 2024/0123989 A1
(43) Pub. Date: Apr. 18, 2024

(54) CONTROL APPARATUS, CONTROL SYSTEM, CONTROL METHOD, AND STORAGE MEDIUM

(71) Applicant: CANON KABUSHIKI KAISHA, Tokyo (JP)

(72) Inventor: Soya FUJIMORI, Kanagawa (JP)

(21) Appl. No.: 18/457,378

(22) Filed: Aug. 29, 2023

(30) Foreign Application Priority Data
Oct. 13, 2022 (JP) 2022-164389

(51) Int. Cl. B60W 30/165; B60W 30/14

(52) U.S. Cl. CPC B60W 30/165; B60W 30/143; B60W 2420/42

(57) ABSTRACT

A control apparatus is configured to control driving of a caravan of vehicles on a same lane by communication. The control apparatus includes a memory storing instructions, and a processor configured to execute the instructions to detect that a target vehicle driving in a lane next to the caravan is putting blinker, and change at least one distance between the vehicles in the caravan in a case where it is detected that the target vehicle is putting blinker.

### BACKGROUND

### Technical Field

One of the aspects of the embodiments relates to a control apparatus, a control system, a control method, and a storage medium.

### Description of Related Art

Conventional caravan (convoy or motorcade) driving control controls the driving of a caravan of vehicles using Cooperative Adaptive Cruise Control (CACC). This control enables caravan driving in which only the leading vehicle is manned and the following vehicles are unmanned in the plurality of vehicles in the caravan.

However, for example, the caravan may block an interchange (IC) exit or service area (SA)/parking area (PA) entrance of a highway, and a vehicle driving in the next (adjacent) lane may not be able to enter the IC exit or SA/PA entrance of the highway. In this case, it is conceivable to control the caravan so as to increase a distance between vehicles (inter-vehicle distance or space), but the widened distance between vehicles may cause a vehicle other than the vehicle trying to enter the IC exit or SA/PA entrance of the highway, to cut in the caravan.

Japanese Patent Laid-Open No. 2015-022421 discloses a method for increasing a distance between vehicles by decelerating the vehicle behind a cutting position near the highway exit in a case where a forward monitoring camera detects that a vehicle driving in the next lane has crossed over the white lane to try to cut in the caravan.

However, the method disclosed in Japanese Patent Laid-Open No. 2015-022421 requires the vehicle driving in the next lane to try to cut in the trucks in the caravan before the trucks widen the distance between them.

### SUMMARY

A control apparatus according to one aspect of the embodiment is configured to control driving of a caravan of vehicles on a same lane by communication. The control apparatus includes a memory storing instructions, and a processor configured to execute the instructions to detect that a target vehicle driving in a lane next to the caravan is putting blinker, and change at least one distance between the vehicles in the caravan in a case where it is detected that the target vehicle is putting blinker. A control method corresponding to the above control apparatus also constitutes another aspect of the embodiment. A storage medium storing a program that constitutes a computer to execute the above control method also constitutes another aspect of the embodiment.

A control system according to another aspect of the embodiment is configured to control driving of a caravan of vehicles on a same lane by communication. The control system includes a communication unit configured to perform the communication among the vehicles, an imaging unit configured to image at least one of a front and a back of the caravan, a detector configured to detect a target vehicle driving in a lane next to the caravan and putting blinker based on image data acquired from the imaging unit, a driving unit configured to accelerate or decelerate at least one of the vehicles in the caravan, and a control unit configured to control at least one distance between the vehicles in the caravan using the driving unit. The control unit changes the distance in a case where the target vehicle putting blinker is detected.

Further features of the disclosure will become apparent from the following description of embodiments with reference to the attached drawings.

### BRIEF DESCRIPTION OF THE DRAWINGS

FIG. 1 is an explanatory diagram of a caravan according to each embodiment.

FIG. 2 is a block diagram of a control system according to a first embodiment.

FIG. 3 is a flowchart illustrating an operation of the control system according to the first embodiment.

FIGS. 4A and 4B are explanatory diagrams of an operation during blinker detection according to the first embodiment.

FIG. 5 is a block diagram of a control system according to a second embodiment.

FIG. 6 is a flowchart illustrating an operation of the control system according to the second embodiment.

FIGS. 7A and 7B are explanatory diagrams of an operation during blinker detection according to the second embodiment.

FIGS. 8A and 8B are explanatory diagrams of an operation during blinker detection according to the second embodiment.

FIGS. 9A and 9B are explanatory diagrams of an operation during blinker detection according to the second embodiment.

FIG. 10 is a block diagram of a control system according to a third embodiment.

FIG. 11 is a flowchart illustrating an operation of the control system according to the third embodiment.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure. Corresponding elements in respective figures will be designated by the same reference numerals, and a duplicate description thereof will be omitted.

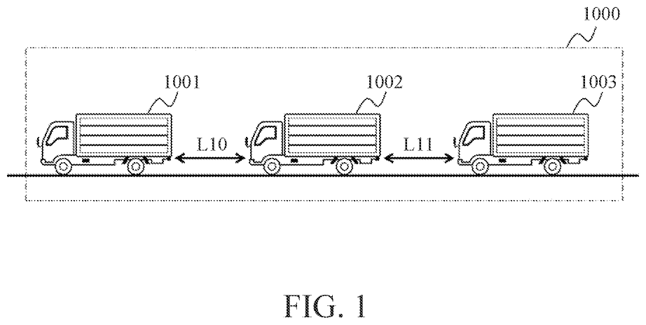

Referring now to FIG. 1, a description will be given of a caravan 1000 according to each embodiment. FIG. 1 is an explanatory diagram of the caravan 1000. The caravan 1000 includes a plurality of vehicles driving on the same lane. Each vehicle in the caravan 1000 includes a control system 200 that controls the driving of its own vehicle according to a relative positional relationship between its own vehicle and the preceding vehicle(s). The control system 200 is a caravan driving control system that controls the driving of the caravan 1000 by wirelessly communicating with each other.

The caravan 1000 includes a manned vehicle 1001 as the leading vehicle and unmanned vehicles 1002 and 1003 as the following vehicles. Reference numeral L10 denotes a distance between the manned vehicle 1001 and the unmanned vehicle 1002, and reference numeral L11 denotes a distance between the unmanned vehicles 1002 and 1003. During normal caravan driving, the distances L10 and L11 are both controlled to an (inter-vehicle) distance (first distance) x1, such as 10 meters. In this embodiment, as an example, the caravan 1000 includes three vehicles, the manned vehicle 1001 and unmanned vehicles 1002 and 1003 that follow the manned vehicle 1001, but the embodiment is not limited to this example. For example, the caravan 1000 may include two vehicles, or four or more vehicles. Each embodiment will be described below.

### First Embodiment

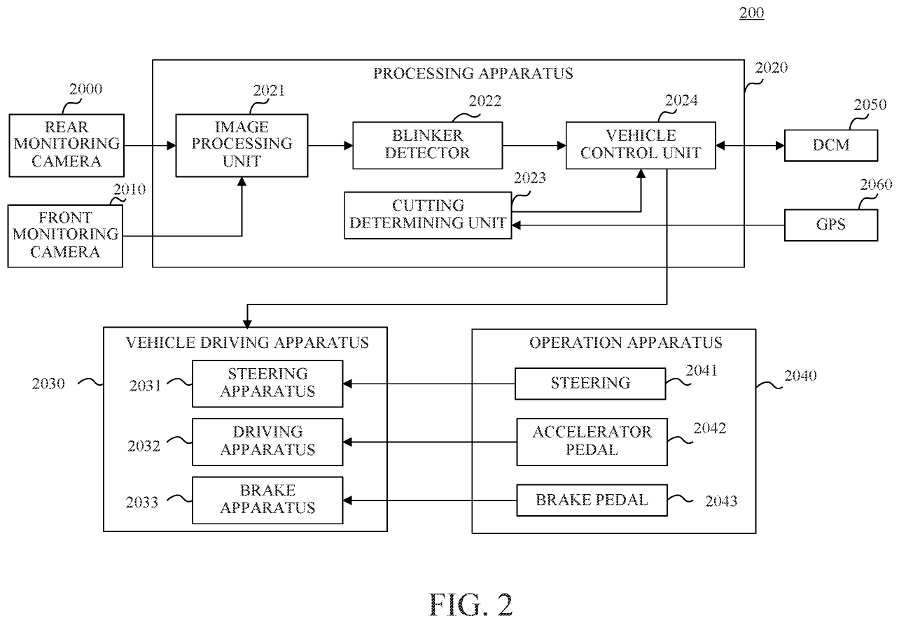

Referring now to FIG. 2, a description will be given of a control system 200 that performs caravan driving control of vehicles in the caravan according to a first embodiment. FIG. 2 is a block diagram of the control system 200.

The control system 200 includes a rear monitoring camera 2000, a front monitoring camera 2010, a processing apparatus 2020, a vehicle driving apparatus 2030, an operation apparatus 2040, a data communication module (DCM) 2050, and a global positioning system (GPS) 2060, and controls the driving of a plurality of vehicles in the caravan on the same lane by communication.

The rear monitoring camera 2000 includes a camera (image pickup apparatus) for imaging the back of the vehicle, and has an optical unit and imaging unit (not illustrated). The optical unit has an optical system including lenses and the like. An optical object image formed by the optical unit is converted into an electric signal by an image sensor of the imaging unit and transmitted to an image processing unit 2021 of the processing apparatus 2020. The front monitoring camera 2010 includes a camera (image pickup apparatus) for imaging the front of the vehicle, and has an optical unit and imaging unit (not illustrated). The optical unit has an optical system including lenses and the like. An optical object image formed by the optical unit is converted into an electric signal by an image sensor of the imaging unit and transmitted to the image processing unit 2021. This embodiment using the rear monitoring camera 2000 can detect a blinker (turn signal) operation of a vehicle trying to cut in the caravan near the side of the last (rearmost or trailing) vehicle that cannot be captured by the front monitoring camera 2010.

The operation apparatus 2040 is operated by the driver to manually drive the vehicle, and has a steering wheel 2041, an accelerator pedal 2042, a brake pedal 2043, and the like. The steering wheel 2041 is rotatably supported, and is configured to turn the vehicle in a case where the driver manually turns the steering wheel to change a steering angle of the steering wheel of the vehicle. The steering angle of the steering wheel 2041 is detected by a rotation angle sensor (not illustrated). The accelerator pedal 2042 is swingably supported and is configured to move forward or backward in a case where the driver steps on it with his or her leg to accelerate the vehicle, thereby changing the driving force to the driving wheels of the vehicle. An accelerator pressing amount of the accelerator pedal 2042 is detected by a pressing amount sensor (not illustrated). The brake pedal 2043 is swingably supported and is configured to be decelerated or stopped by the driver's leg to decelerate or stop the vehicle, applying a braking force to the front and rear wheels of the vehicle. A brake pressing amount of the brake pedal 2043 is detected by a pressing amount sensor (not illustrated). The operation apparatus 2040 is connected to the processing apparatus 2020, and outputs to the processing apparatus 2020 an operation amount for controlling the driving of the vehicle, such as the steering angle, the accelerator pressing amount, and the brake pressing amount.

The vehicle driving apparatus 2030 is an apparatus for driving the vehicle (driving unit for accelerating or decelerating the vehicle) and has a steering apparatus 2031, a driving apparatus 2032, and a braking apparatus 2033. The steering apparatus 2031, for example, changes the steering angle of the steering wheel of the vehicle by a steering actuator such as a motor. The driving apparatus 2032 is configured to generate driving force to the driving wheels of the vehicle, and includes, for example, a driving source that is either an engine alone, a rotating electric machine alone, or a combination of the engine and the rotating electric machine, and a transmission that transmits the driving force from the driving source to the driving wheels. The braking apparatus 2033 includes, for example, a hydraulic braking apparatus that brings the brake pad into contact with the brake rotor by hydraulic pressure generated by a braking actuator. In the vehicle driving apparatus 2030, the steering apparatus 2031, the driving apparatus 2032, and the braking apparatus 2033 are respectively input with operation amounts such as the steering angle, accelerator pressing amount, and brake pressing amount directly or via the connected processing apparatus 2020. Steering control, driving control, and braking control of the steering apparatus 2031, the driving apparatus 2032, and the braking apparatus 2033 are performed based on this operation amount, respectively.

The DCM 2050 is a data communication module, that is, a wireless communication function component, which wirelessly connects the plurality of vehicles in the caravan 1000 and transmits and receives information among the plurality of vehicles. The DCM 2050 in this embodiment is a CACC apparatus that transmits and receives information by communicating with each vehicle in the caravan 1000. The DCM 2050 communicates with a communication unit outside the vehicle by wide-ranging wireless and narrow-ranging wireless communications. The wide-ranging wireless system includes, for example, radio (AM, FM), TV (UHF, 4K, 8K), TEL, GPS, and WiMAX (registered trademark). The narrow-ranging wireless system includes ETC/DSRC, VICS (registered trademark), wireless LAN, and millimeter wave communication. The DCM 2050 is connected to the processing apparatus 2020 and can transmit and receive information to and from the processing apparatus 2020. The DCM 2050 can transmit information input to the processing apparatus 2020, for example, vehicle information such as speed and operation amount relating to the driving state of the vehicle, vehicle surrounding information, and position information to the processing apparatus 2020 of other vehicles other than its own vehicle in the caravan 1000.

The processing apparatus 2020 is a control apparatus that controls, by communication, the driving of a plurality of vehicles in the caravan 1000 on the same lane, and includes the image processing unit 2021, a blinker detector 2022, a cutting (acceptance) determining unit 2023, and a vehicle control unit 2024. The hardware configuration of the processing apparatus 2020 is a known electronic control unit. The processing apparatus 2020 includes a CPU (Central Processing Unit) that performs calculations or controls, a ROM (Read Only Memory) that is a main memory, a RAM (Random Access Memory), and an interface. Basic setting data and programs in this embodiment are stored in the ROM, and the CPU reads a program corresponding to the processing content from the ROM, loads it in the RAM, and executes the operation of each block.

The image processing unit 2021 develops electrical signals (image data) transmitted from the rear monitoring camera 2000 and the front monitoring camera 2010 into images and performs image processing such as Wide Dynamic Range (WDR) correction, gamma correction, LUT processing, and distortion correction. This image processing improves an image recognition rate in image detection, which will be described below. The image that has undergone the image processing is transmitted to the blinker detector 2022.

The blinker detector 2022 is a detector for detecting a vehicle driving in a lane adjacent to the caravan 1000 and putting (or giving) blinker (using a turn signal) based on image data obtained from at least one imaging unit of the rear monitoring camera 2000 or the front monitoring camera 2010. The blinker detector 2022 detects the blinker operation of the rear side vehicle in the captured image of the rear monitoring camera 2000 processed by the image processing unit 2021 and transmits the detected information to the vehicle control unit 2024. The cutting determining unit 2023 is a determining unit for determining whether or not the current position can accept a cutting vehicle (whether to accept cutting (pulling or insertion) in the caravan of the vehicle in the adjacent lane) based on the current position information (position data) sent from the GPS 2060. A determination result by the cutting determining unit 2023 is transmitted to the vehicle control unit 2024.

The vehicle control unit 2024 is a control unit configured to control at least one distance between vehicles in the caravan 1000. The vehicle control unit 2024 determines the operation of the vehicle based on the information from the blinker detector 2022, the cutting determining unit 2023, and the DCM 2050. Then, the vehicle control unit 2024 controls the driving state of its own vehicle by controlling the vehicle driving apparatus 2030 based on the determination result. In addition, the vehicle control unit 2024 not only controls the own vehicle but also controls caravan driving including the following vehicles together with the vehicle control unit 2024 of the following vehicle via the DCM 2050. The caravan driving control includes control processing for caravan driving that forms a caravan of adjacent vehicles arranged in a row in a driving direction, maintains distances (or spaces) between the vehicles in the caravan, and makes the following vehicles follow the leading vehicle.

The GPS 2060 is a position acquiring unit for detecting (acquiring) the current position (position data) of the own vehicle. The GPS 2060 is connected to the cutting determining unit 2023 in the processing apparatus 2020, and outputs the detected current position of the vehicle to the cutting determining unit 2023 as position information.

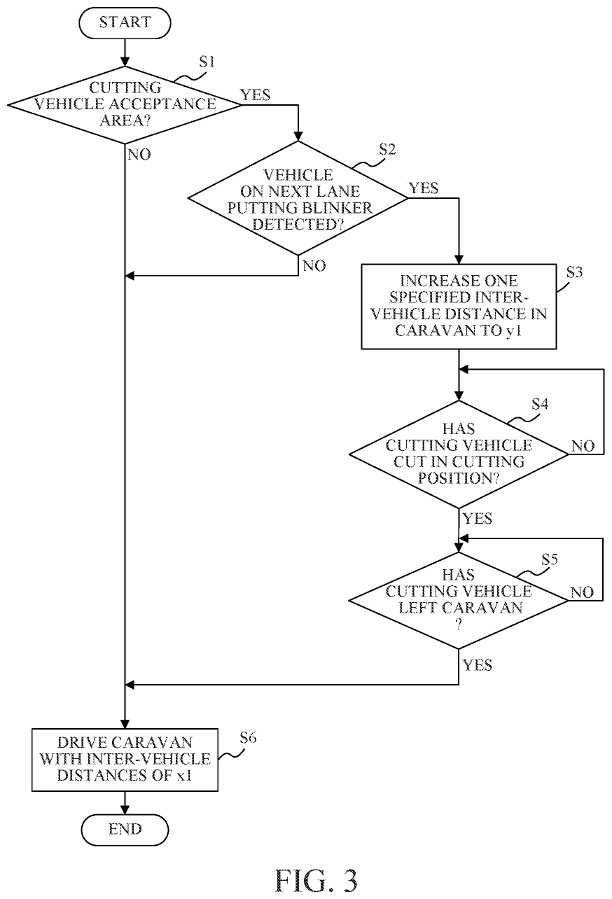

Referring now to FIG. 3, a description will be given of the operation of the control system 200 according to this embodiment. FIG. 3 is a flowchart illustrating an operation of the control system 200.

First, in step S1, the control system 200 sends the current position information (information indicating the current position of the vehicle) acquired by the GPS 2060 to the cutting determining unit 2023. The cutting determining unit 2023 determines whether or not the current position of the driving vehicle (current position) is a position (cutting vehicle acceptance area) that accepts (allows) another vehicle to cut in the caravan 1000. In a case where the cutting determining unit 2023 determines that the current position is not the position (cutting vehicle acceptance area) that accepts the other vehicle to cut in the caravan 1000, the flow proceeds to step S6. On the other hand, in a case where the cutting determining unit 2023 determines that the current position is the position that accepts the other vehicle to cut in the caravan 1000, the flow proceeds to step S2.

In step S2, the blinker detector 2022 determines whether or not there is a vehicle driving in a lane next to the lane in which the caravan 1000 is driving and putting blinker toward the lane in which the caravan 1000 is driving (whether or not the blinker has been detected). In a case where the blinker is detected by the blinker detector 2022, the flow proceeds to step S3. On the other hand, in a case where the blinker is not detected by the blinker detector 2022, the flow proceeds to step S6.

In step S3, the control system 200 transmits the information detected by the blinker detector 2022 to the vehicle control unit 2024, and determines a distance between the vehicles (inter-vehicle distance) that allows the other vehicle to cut in the caravan 1000 from among the plurality of vehicles in the caravan 1000. After the control system 200 determines the distance between vehicles that allows cutting, it sends control information to another vehicle in the caravan 1000 via the DCM 2050 to increase the distance between the vehicles so that the other vehicle can cut in the caravan 1000. In the distances among the plurality of vehicles in the caravan 1000, the inter-vehicle distance that accepts cutting is, for example, a distance between a vehicle that has detected the blinker and a vehicle just behind that vehicle (the vehicle that has detected the blinker) in the caravan 1000. Alternatively, the inter-vehicle distance that accepts cutting may be a distance between the vehicle that has detected the blinker and a vehicle just ahead of that vehicle (the vehicle that has detected the blinker) in the caravan 1000.

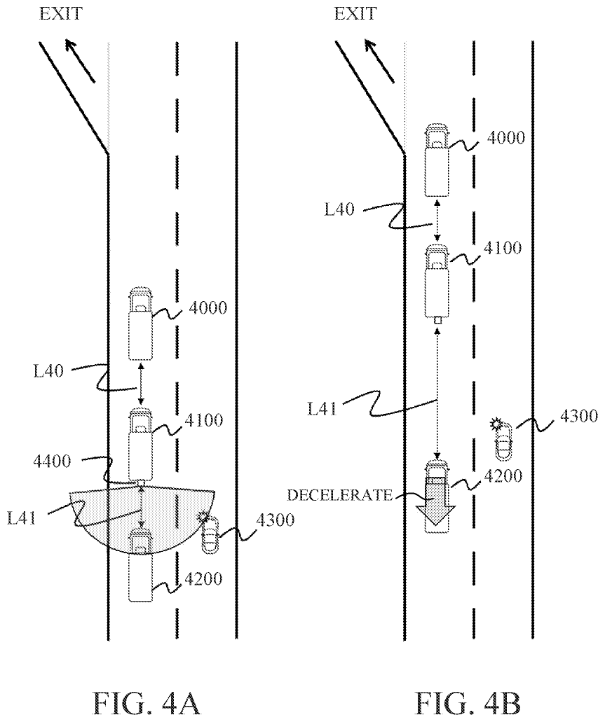

FIGS. 4A and 4B are explanatory diagrams of the operation in a case where the blinker is detected. FIG. 4A illustrates the state in a case where the blinker is detected, and FIG. 4B illustrates the state where the distance L41 is widened after the blinker is detected. As illustrated in FIG. 4A, in a caravan of three vehicles, a manned vehicle 4000, an unmanned vehicle 4100, and an unmanned vehicle 4200, reference numeral L40 denotes a distance between the manned vehicle 4000 and the unmanned vehicle 4100, and reference numeral L41 denotes a distance between the unmanned vehicles 4100 and 4200. At this time, the control system uses the blinker detector to widen the distance L41 between the unmanned vehicle 4100 and the unmanned vehicle 4200 in a case where the blinker operation of a vehicle 4300 driving in the adjacent lane is detected based on the image acquired from the rear monitoring camera 4400 in the unmanned vehicle 4100. For example, as illustrated in FIG. 4B, the vehicle behind the unmanned vehicle 4100, that is, the unmanned vehicle 4200, is decelerated to widen the distance L41.

Thus, the control system transmits control information to another vehicle in the caravan 1000 via the DCM 2050 after determining a distance between vehicles in the caravan 1000 that is to be widened to accept cutting. Based on the control information, the vehicle control unit 2024 changes one inter-vehicle distance between the leading vehicle and the following vehicle or between the following vehicles excluding the leading vehicle so that another vehicle can cut in the caravan from the next lane. In this embodiment, the vehicle control unit 2024 changes the inter-vehicle distance from the inter-vehicle distance (first distance) x1 during normal driving to an inter-vehicle distance (second distance) y1 (x1<y1). In widening the inter-vehicle distance x1 to the inter-vehicle distance y1, the inter-vehicle distance is increased by decelerating all vehicles driving behind the vehicle that has detected the blinker in step S2. For example, as illustrated in FIG. 4A, the distances L40 and L41 are set to the distance x1 (such as 10 meters). In a case where the unmanned vehicle 4100 detects the blinker operation of the vehicle 4300, the distance L41 is widened. In widening the distance L41 to the distance y1 (such as 30 meters), the unmanned vehicle 4200 is decelerated to widen the distance L41. In the inter-vehicle distance becomes the predetermined distance y1, the flow proceeds to step S4.

In step S4, the control system 200 detects whether or not the vehicle putting blinker detected in step S2 has cut in the space widened to the distance y1 in step S3, using the rear monitoring camera 2000 and the front monitoring camera 2010. For example, as illustrated in FIG. 4B, in a case where the distance L41 between the unmanned vehicle 4200 and the vehicle 4300 is widened, the control system 200 determines whether or not the vehicle putting blinker has cut in the caravan using the rear monitoring camera of the unmanned vehicle 4200 and the front monitoring camera of the vehicle 4300. In a case where the control system 200 determines that the vehicle putting blinker has cut in the caravan, the flow proceeds to step S5. On the other hand, in a case where the control system 200 determines that the vehicle putting blinker has not cut in the caravan, step S4 is repeated.

In step S5, the control system 200 determines whether or not the vehicle that cut in the caravan in step S4 has left the caravan 1000, using the rear monitoring camera 2000 and the front monitoring camera 2010. In a case where it is determined that the cutting vehicle does not exist at the cutting position (in a case where it is determined that the cutting vehicle has left the caravan), the flow proceeds to step S6. On the other hand, in a case where it is determined that the cutting vehicle is present at the cutting position (in a case where it is determined that the vehicle that cut in the caravan has not left the caravan), step S5 is repeated.

In step S6, the control system 200 controls the distance between the leading vehicle and the following vehicle and the distance between the following vehicles excluding the leading vehicle to the predetermined distance xl. In a case where the distance at one point between the leading vehicle and the following vehicle and between the following vehicles excluding the leading vehicle becomes the distance xl, the control system 200 ends the series of operations.

In this embodiment, the distance y1 is a uniform width regardless of the type of the cutting vehicle, but this embodiment is not limited to this example. The type of the cutting vehicle determined to emit the blinker in step S3 may be determined using the images captured by the rear monitoring camera 2000 and the front monitoring camera 2010, and the size of the space to be cut may be changed according to the vehicle type. For example, in a case where a motorcycle is about to cut in the caravan, the distance y1 may be set to 20 meters, and in a case where a bus is about to cut in the caravan, the distance y1 may be set to 40 meters.

This embodiment performs the operation illustrated in FIG. 3 regardless of the driving speed of the caravan 1000, but this embodiment is not limited to this example. In a traffic jam on the highway, it may be difficult to increase the distance between vehicles at a specific position. In this case, in a case where the speed of the caravan 1000 is lower than a certain threshold (speed threshold), all distances between vehicles in the caravan 1000 may be made wider than the predetermined distance xl.

### Second Embodiment

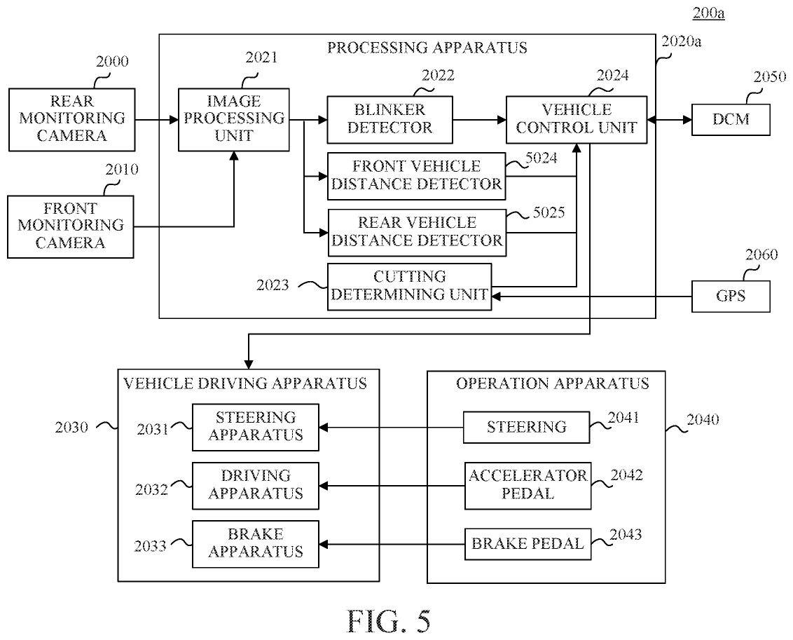

Referring now to FIG. 5, a description will be given of a control system 200a that performs caravan driving control of vehicles in the caravan according to a second embodiment. FIG. 5 is a block diagram of the control system 200a.

The control system 200a according to this embodiment is different from the control system 200 of the first embodiment having the processing apparatus 2020 in that it has a control apparatus 2020a including a front vehicle distance detector 5024 and a rear vehicle distance detector 5025. Since other configurations of the control system 200a are the same as those of the control system 200, a description thereof will be omitted.

The image processing unit 2021 develops electrical signals transmitted from the rear monitoring camera 2000 and the front monitoring camera 2010 into images, and performs processing such as WDR correction, gamma correction, LUT processing, and distortion correction. This processing improves the recognition rate of images during image detection, which will be described below. The processed image is transmitted to a blinker detector 2022, a front vehicle distance detector 5024, and a rear vehicle distance detector 5025.

The front vehicle distance detector 5024 detects a vehicle from the image processed by the image processing unit 2021 and calculates a distance between the own vehicle and the detected vehicle from changes in the position and size of the detected vehicle. The front vehicle distance detector 5024 then transmits the calculated distance information to vehicle control unit 2024. The rear vehicle distance detector 5025 detects a vehicle from the image processed by the image processing unit 2021 and calculates a distance between the own vehicle and the detected vehicle from changes in the position and size of the detected vehicle. The rear vehicle distance detector 5025 then transmits the calculated distance information to the vehicle control unit 2024.

The vehicle control unit 2024 determines the operation of the vehicle based on the output information from the blinker detector 2022, the cutting determining unit 2023, the DCM 2050, the front vehicle distance detector 5024, and the rear vehicle distance detector 5025. Then, the vehicle control unit 2024 controls the driving state of the own vehicle by controlling the vehicle driving apparatus 2030 based on the determination result. In addition, the vehicle control unit 2024 not only controls the own vehicle, but also controls caravan driving of following vehicles using the DCM 2050.

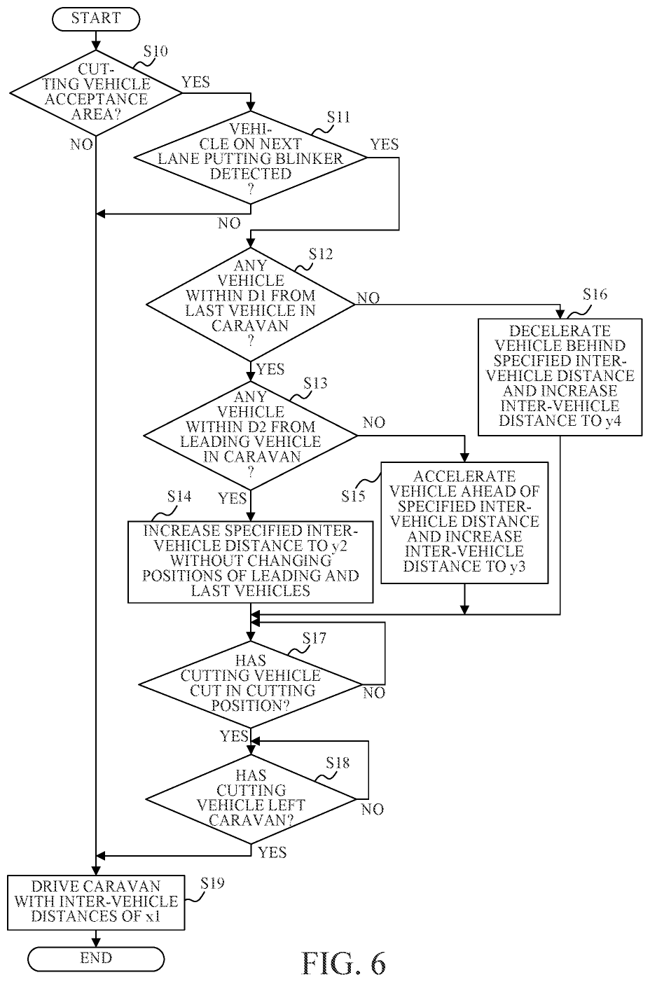

Referring now to FIG. 6, a description will be given of the operation of the control system 200a according to this embodiment. FIG. 6 is a flowchart illustrating the operation of the control system 200a.

First, in step S10, the control system 200a sends the current position information (information indicating the current position of the vehicle) acquired by the GPS 2060 to the cutting determining unit 2023. The cutting determining unit 2023 determines whether or not the current position of the driving vehicle (current position) is a position (cutting vehicle acceptance area) that accepts (allows) another vehicle to cut in the caravan 1000. In a case where the cutting determining unit 2023 determines that the current position is not the position (cutting vehicle acceptance area) that accepts the other vehicle to cut in the caravan, the flow proceeds to step S19. On the other hand, in a case where the cutting determining unit 2023 determines that the current position is the position that accepts the other vehicle to cut in the caravan, the flow proceeds to step S11.

In step S11, the blinker detector 2022 determines whether or not there is a vehicle driving in a lane next to the lane in which the caravan 1000 is driving and putting blinker toward the lane in which the caravan 1000 is driving (whether or not the blinker has been detected). In a case where the blinker is detected by the blinker detector 2022, the detection of the blinker is transmitted to other vehicles in the caravan 1000 via the DCM 2050, and the flow proceeds to step S12. On the other hand, in a case where the blinker is not detected by the blinker detector 2022, the flow proceeds to step S19.

In step S12, the control system 200a measures a distance between a vehicle driving on the same lane as that of the caravan 1000 and located behind the last vehicle in the caravan 1000 and the last vehicle in the caravan 1000, using the rear vehicle distance detector 5025. The control system 200a determines whether or not the distance between the vehicle driving behind the last vehicle in the caravan 1000 and the last vehicle in the caravan 1000 is less than a threshold (first threshold) D1, using the vehicle control unit 2024. In a case where the control system 200a determines that the distance between the vehicle driving behind the last vehicle in the caravan 1000 and the last vehicle in the caravan 1000 is less than the threshold D1, the flow proceeds to step S13. On the other hand, in a case where the control system 200a determines that the distance between the vehicle driving behind the last vehicle in the caravan 1000 and the last vehicle in the caravan 1000 is equal to or greater than the threshold D1, the flow proceeds to step S16.

In step S13, the control system 200a measures a distance between a vehicle driving on the same lane as that of the caravan 1000 and located ahead of the leading vehicle of the caravan 1000 and the leading vehicle in the caravan 1000, using the front vehicle distance detector 5024. The control system 200a then determines whether or not the distance between the leading vehicle in the caravan 1000 and the vehicle driving ahead of the leading vehicle in the caravan 1000 is less than a threshold (second threshold) D2, using the vehicle control unit 2024. In a case where it is determined that the distance between the vehicle driving ahead of the leading vehicle in the caravan 1000 and the leading vehicle in the caravan 1000 is less than the threshold D2, the flow proceeds to step S14. On the other hand, in a case where it is determined that the distance between the leading vehicle in the caravan 1000 and the vehicle driving ahead of the leading vehicle in the caravan 1000 is equal to or greater than the threshold D2, the flow proceeds to step S15.

In step S14, the control system 200a accelerates and decelerates the vehicles other than the leading vehicle and the last vehicle of the caravan 1000 without changing the distance from the leading vehicle to the trailing vehicle of the caravan 1000. Thereby, the control system 200a widens a specified inter-vehicle distance to the distance (second distance) y2, and creates a space in the caravan 1000 for the cutting vehicle to cut in the caravan. From the determination result of step S12, the distance between the vehicle driving behind the last vehicle in the caravan 1000 and the last vehicle in the caravan 1000 is less than the threshold D1, which is considered to be a distance at which safety can be secured. Therefore, in a case where the last vehicle of the caravan 1000 is decelerated, the distance between the last vehicle and the vehicle driving behind the last vehicle becomes narrower, which is dangerous. From the determination result of step S13, the distance between the leading vehicle in the caravan 1000 and the vehicle driving ahead of the leading vehicle in the caravan 1000 is less than the threshold D2, which is considered to be a distance at which safety can be secured. Therefore, accelerating the leading vehicle of the caravan 1000 is dangerous to the vehicle driving ahead of the caravan 1000. To avoid danger, a cutting space with the distance y2 in the caravan 1000 is created by accelerating and decelerating the vehicles other than the leading vehicle and the last vehicle in the caravan 1000 without changing the distance from the leading vehicle to the last vehicle in the caravan 1000.

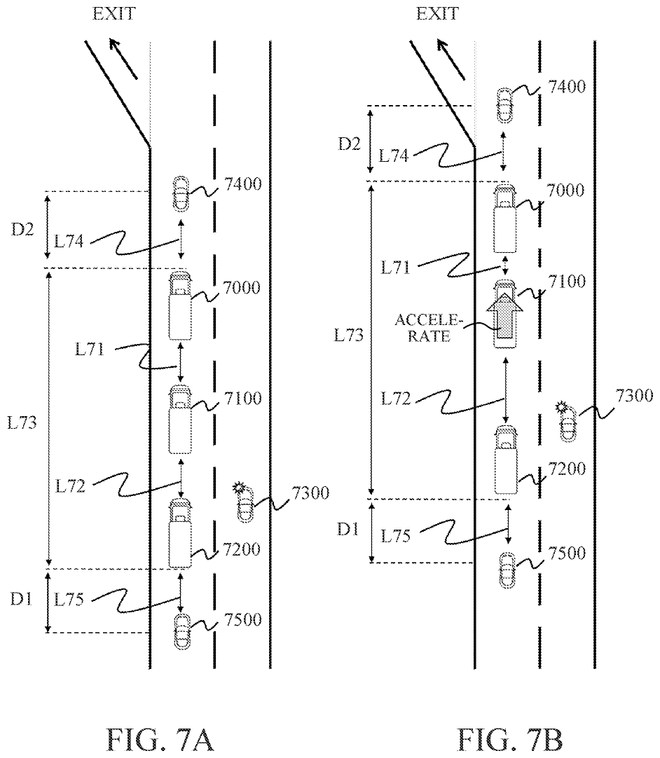

Referring now to FIGS. 7A and 7B, a description will be given of an example of the operation (step S14) at this time. FIGS. 7A and 7B are explanatory diagrams of the operation in a case where the blinker is detected. FIG. 7A illustrates a state before a distance L72 is widened, and FIG. 7B illustrates a state after the blinker is detected and the distance L72 is widened without changing a distance L73.

As illustrated in FIG. 7A, reference numeral L71 denotes a distance between a manned vehicle 7000 and an unmanned vehicle 7100 in the caravan consisting of three vehicles, the manned vehicle 7000, the unmanned vehicle 7100, and an unmanned vehicle 7200, and reference numeral L72 is a distance between the unmanned vehicles 7100 and 7200. Reference numeral L74 denotes a distance between the manned vehicle 7000 and a vehicle 7400 driving ahead of the manned vehicle 7000, and reference numeral L75 denotes a distance between the unmanned vehicle 7200 and a vehicle 7500 driving behind the unmanned vehicle 7200.

As illustrated in FIG. 7B, in a case where the unmanned vehicle 7100 detects the blinker operation of the vehicle 7300, a cutting space for the vehicle 7300 is created in the distance L72. At this time, the distance L74 and the distance L75 are less than the thresholds D2 and D1, respectively, acceleration of the manned vehicle 7000 and the deceleration of the unmanned vehicle 7200 pose danger to the vehicles 7400 and 7500. Therefore, in widening the space with the distance L72, only the unmanned vehicle 7100 is accelerated without changing the speeds of the manned vehicle 7000 and unmanned vehicle 7200. For example, assume a distance between vehicles L71 and L72 before the acceleration of the unmanned vehicle 7100 is 10 meters. Then, by accelerating only the unmanned vehicle 7100, the distance L72 is set to 16 meters, and the distance L71 is set to 4 meters. Thereby, a cutting space can be created by setting the distance L72 to the distance y2 without changing the distance L73 from the manned vehicle 7000, which is the leading vehicle of the caravan, to the unmanned vehicle 7200, which is the last vehicle of the caravan. This embodiment has described the method for widening the distance L72 illustrated in FIGS. 7A and 7B, but is not limited to this example. For example, by decelerating only the unmanned vehicle 7100 without changing the speeds of the manned vehicle 7000 and the unmanned vehicle 7200, the distance L71 may be widened. After the specific distance is set to the distance y2 in step S14 of FIG. 6, the flow proceeds to step S17.

In step S15, the control system 200a accelerates all the vehicles in the caravan 1000 driving ahead of the cutting accepting space, thereby creating the cutting space with an inter-vehicle distance y3 (second distance) in the caravan 1000. The cutting accepting position (inter-vehicle distance) is an inter-vehicle distance between the vehicle that has detected the blinker in the caravan 1000 and a vehicle driving just behind that vehicle (that has detected the blinker). From the determination result of step S12, the distance between the vehicle driving behind the last vehicle in the caravan 1000 and the last vehicle in the caravan 1000 is less than the threshold D1, which is considered to be a distance at which safety can be secured. Therefore, in a case where the last vehicle of the caravan 1000 is decelerated, the distance between the last vehicle and the vehicle driving behind the last vehicle becomes narrower, which is dangerous.

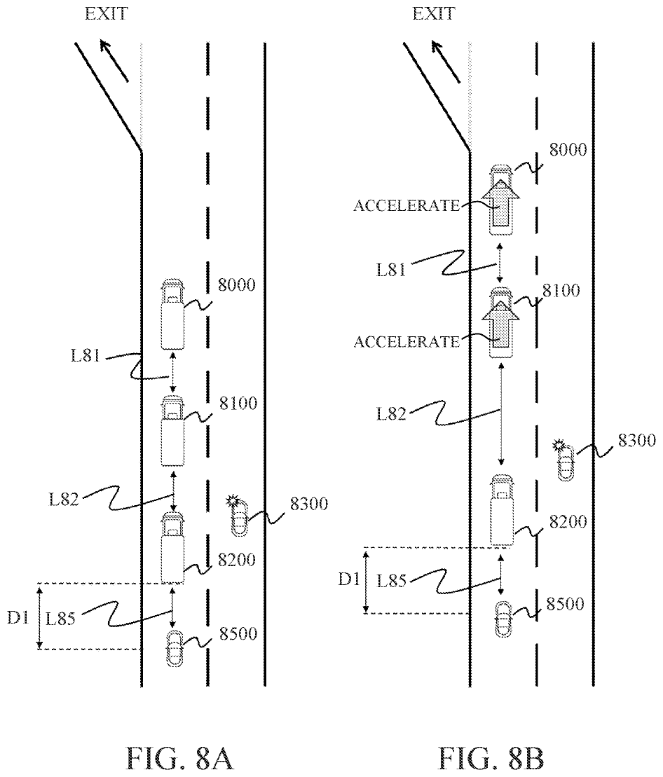

Referring now to FIGS. 8A and 8B, a description will be given of an example of the operation (step S15) at this time. FIGS. 8A and 8B are explanatory diagrams of the operation in a case where the blinker is detected. FIG. 8A illustrates a state before a distance L82 is widened, and FIG. 8B illustrates a state after the blinker is detected and the distance L82 is widened.

As illustrated in FIG. 8A, reference numeral L81 denotes a distance between a manned vehicle 8000 and an unmanned vehicle 8100 in the caravan consisting of the manned vehicle 8000, the unmanned vehicle 8100, and an unmanned vehicle 8200, and reference numeral L82 denotes a distance between the unmanned vehicle 8100 and the unmanned vehicle 8200. Reference numeral L85 denotes a distance between the unmanned vehicle 8200 and a vehicle 8500 driving behind the unmanned vehicle 8200.

As illustrated in FIG. 8B, in a case where the unmanned vehicle 8100 detects the blinker of the vehicle 8300, a cutting space for the vehicle 8300 is created in the distance L82. At this time, the distance L85 is less than the threshold D1, so the deceleration of the unmanned vehicle 8200 poses a danger to the vehicle 8500. Therefore, in widening the space with the distance L82, only the manned vehicle 8000 and the unmanned vehicle 8100 are accelerated to maintain the original distance x1 for the distance L81 and set the distance y3 only for the distance L82 to create the cutting space. After the specific distance is set to the distance y3 in step S15 of FIG. 6, the flow proceeds to step S17.

In step S16, the control system 200a decelerates the vehicle in the caravan 1000 driving behind the cutting accepting space, thereby creating the cutting space with an inter-vehicle distance y4 (second distance) in the caravan 1000. The cutting accepting position (inter-vehicle distance) is an inter-vehicle distance between the vehicle that has detected the blinker in the caravan 1000 and a vehicle driving just behind that vehicle (that has detected the blinker). From the determination result of step S13, the distance between the vehicle driving ahead of the leading vehicle in the caravan 1000 and the leading vehicle in the caravan is less than the threshold D2, which is considered to be a distance at which safety can be secured. Therefore, in a case where the leading vehicle of the caravan 1000 is accelerated, the distance between the leading vehicle and the vehicle driving ahead of the leading vehicle becomes narrower, which is dangerous to the vehicle driving ahead of the caravan 1000.

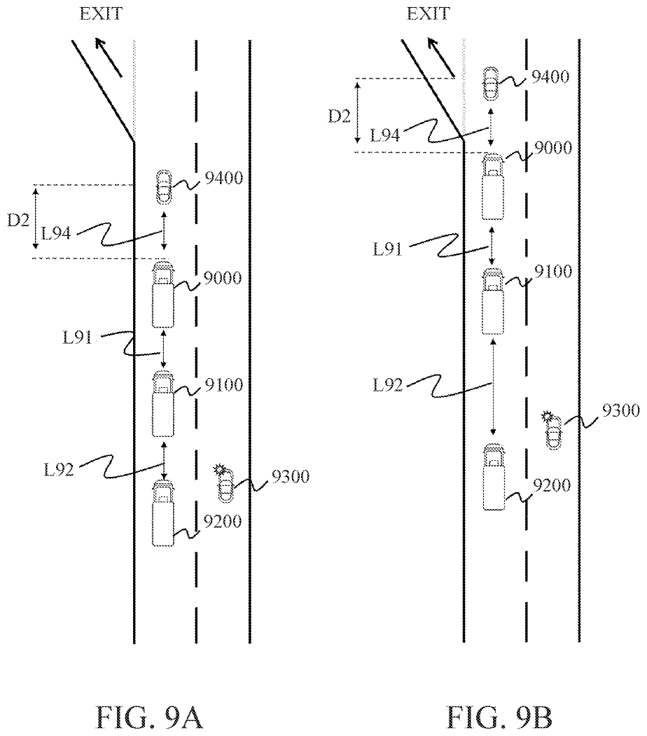

Referring now to FIGS. 9A and 9B, a description will be given of an example of the operation (step S16) at this time. FIGS. 9A and 9B are explanatory diagrams of the operation in a case where the blinker is detected. FIG. 9A illustrates a state before a distance L92 is widened, and FIG. 9B illustrates a state after the blinker is detected and the distance L92 is widened.

As illustrated in FIG. 9A, reference numeral L91 is a distance between a manned vehicle 9000 and an unmanned vehicle 9100 in the caravan consisting of the manned vehicle 9000, the unmanned vehicle 9100, and an unmanned vehicle 9200, reference numeral L92 denotes a distance between the unmanned vehicle 9100 and the unmanned vehicle 9200, and reference numeral L94 is a distance between the manned vehicle 9000 and a vehicle 9400 driving ahead of the manned vehicle 9000.

As illustrated in FIG. 9B, in a case where the unmanned vehicle 9100 detects the blinker of the vehicle 9300, a cutting space for the vehicle 9300 is created in the distance L92. At this time, the distance L94 is less than the threshold D2, so the acceleration of the manned vehicle 9000 poses a danger to the vehicle 9400. Therefore, in widening the space with the distance L92, the unmanned vehicle 9200 is decelerated to maintain the original length of the distance L91 and set a distance y4 to the distance y4, thereby creating the cutting space. After the specific distance is set to the distance y4 in step S16 of FIG. 6, the flow proceeds to step S17.

In step S17, the control system 200a determines whether or not the vehicle putting blinker has cut in the position widened to any of the distances y2, y3, and y4 in steps S14 to S16, using the rear monitoring camera 2000 and the front monitoring camera 2010. In a case where the control system 200a determines that the vehicle putting blinker has cut in the caravan, the flow proceeds to step S18. On the other hand, in a case where the control system 200a determines that the vehicle putting blinker has not cut in the caravan, step S17 is repeated.

In step S18, the control system 200a determines whether or not the vehicle that cut in the caravan in step S17 has left the caravan 1000, using the rear monitoring camera 2000 and the front monitoring camera 2010. In a case where the control system 200a determines that the cutting vehicle does not exist at the cutting position (in a case where the control system 200a determines that the cutting vehicle has left the caravan), the flow proceeds to step S19. On the other hand, in a case where the control system 200a determines that the vehicle that cut in the caravan is present at the cutting position (in a case where the control system 200a determines that the vehicle that cut in the caravan has not left the caravan), step S18 is repeated.

In step S19, the control system 200a controls the distance between the leading vehicle and the following vehicle and the distance between the following vehicles excluding the leading vehicle to the predetermined distance xl. In a case where these distances become the distance xl, the control system 200a terminates the series of operations.

### Third Embodiment

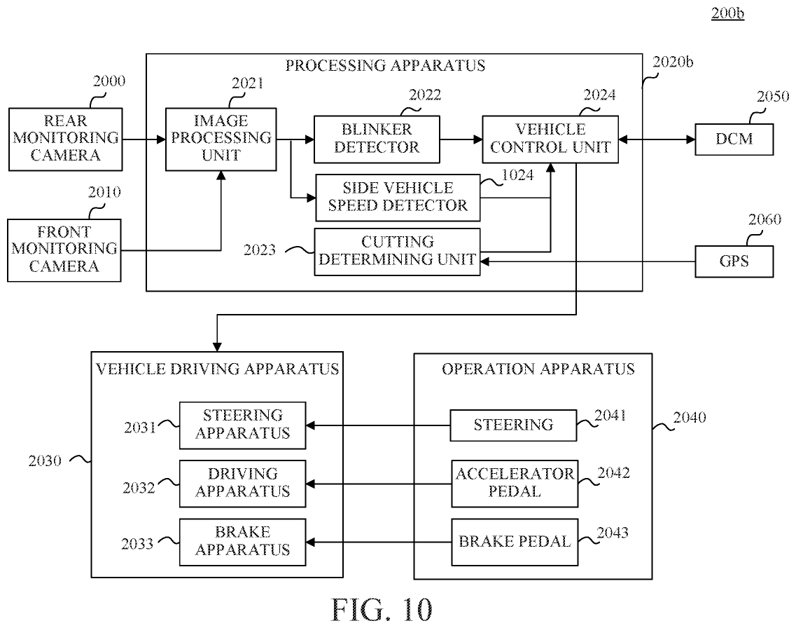

Referring now to FIG. 10, a description will be given of a control system 200b that performs caravan driving control of vehicles in the caravan according to a third embodiment. FIG. 10 is a block diagram of the control system 200b.

The control system 200b according to this embodiment is different from the control system 200 of the first embodiment having the processing apparatus 2020 in that it has a control apparatus 2020b with a side vehicle speed detector 1024. Since other configurations of the control system 200b are the same as those of the control system 200, a description thereof will be omitted.

The image processing unit 2021 develops electrical signals transmitted from the rear monitoring camera 2000 and the front monitoring camera 2010 into images, and performs processing such as WDR correction, gamma correction, LUT processing, and distortion correction. This processing improves the recognition rate of images during image detection, which will be described below. The processed image is transmitted to the blinker detector 2022 and the side vehicle speed detector 1024.

The side vehicle speed detector 1024 acquires the speed of the vehicle driving in the lane next to the driving lane of the caravan 1000, using the image processed by the image processing unit 2021. The side vehicle speed detector 1024 detects a vehicle from the image processed by the image processing unit 2021 and calculates the speed of the vehicle from changes in the position and size of the detected vehicle, the speed of the own vehicle, and the like. Then, side vehicle speed detector 1024 transmits the calculated speed information to the vehicle control unit 2024.

The vehicle control unit 2024 determines the operation of the vehicle based on the output information from the blinker detector 2022, the cutting determining unit 2023, the DCM 2050, and the side vehicle speed detector 1024. Then, the vehicle control unit 2024 controls the driving state of the own vehicle by controlling the vehicle driving apparatus 2030 based on the determination result. The vehicle control unit 2024 not only controls the own vehicle, but also controls caravan driving of following vehicles via the DCM 2050.

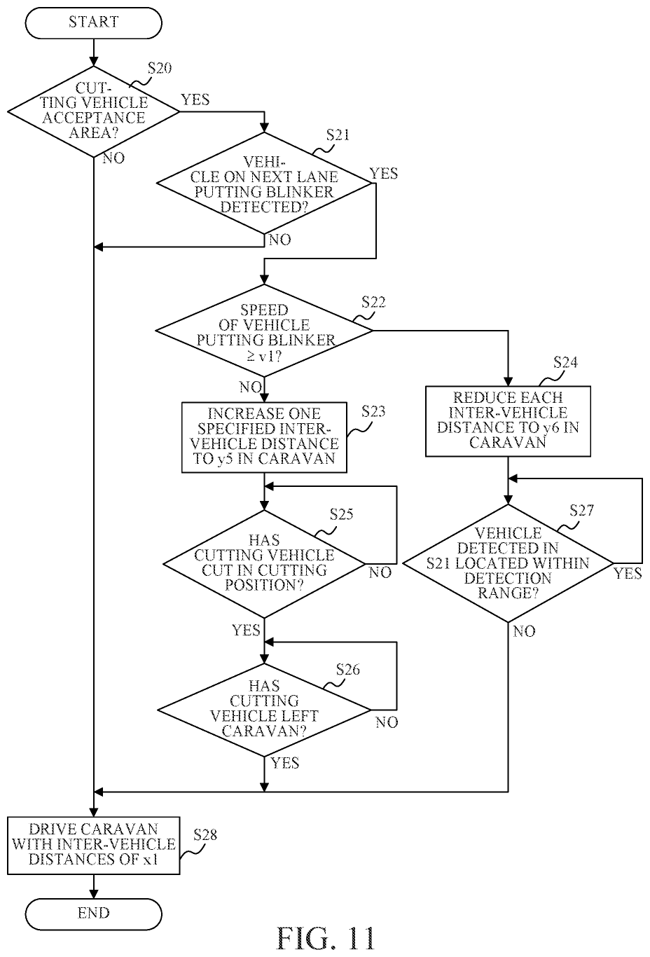

Referring now to FIG. 11, a description will be given of an operation of the control system 200b according to this embodiment. FIG. 11 is a flowchart illustrating the operation of the control system 200b.

First, in step S20, the control system 200b sends the current position information (information indicating the current position of the vehicle) acquired by the GPS 2060 to the cutting determining unit 2023. The cutting determining unit 2023 determines whether or not the current position of the driving vehicle (current position) is a position (cutting vehicle acceptance area) that accepts another vehicle to cut in the caravan 1000. In a case where the cutting determining unit 2023 determines that the current position is not the position (cutting vehicle acceptance area) that accepts the other vehicle to cut in the caravan 1000, the flow proceeds to step S28. On the other hand, in a case where the cutting determining unit 2023 determines that the current position is the position that accepts the other vehicle to cut in the caravan 1000, the flow proceeds to step S21.

In step S21, the blinker detector 2022 determines whether or not there is a vehicle driving in a lane next to the lane in which the caravan 1000 is driving and putting blinker toward the lane in which the caravan 1000 is driving (whether or not the blinker has been detected). In a case where the blinker is detected by the blinker detector 2022, the detection of the blinker is transmitted to other vehicles in the caravan 1000 via the DCM 2050, and the flow proceeds to step S22. On the other hand, in a case where the blinker is not detected by the blinker detector 2022, the flow proceeds to step S28.

In step S22, the control system 200b determines whether or not the vehicle putting blinker detected in step S21 is a dangerous vehicle. That is, the control system 200b detects the speed of the vehicle that is putting blinker using the side vehicle speed detector 1024. Then, the control system 200b determines whether or not the speed of the vehicle putting blinker is equal to or higher than a threshold (third threshold) v1, using the vehicle control unit 2024. In a case where the control system 200b determines that the speed of the vehicle putting blinker is equal to or higher than the threshold v1, the control system 200b determines that the vehicle putting blinker is a dangerous vehicle, and the flow proceeds to step S24. On the other hand, in a case where the control system 200b determines that the speed of the vehicle with the blinker is lower than the threshold v1, the control system 200b determines that the vehicle putting blinker is not a dangerous vehicle, and the flow proceeds to step S23.

In step S23, the control system 200b transmits the information detected by the blinker detector 2022 to the vehicle control unit 2024, and determines one of the inter-vehicle distances in the caravan 1000 that accepts cutting of another vehicle. After the control system 200b determines the cutting accepting inter-vehicle distance, it sends control information to the other vehicles in the caravan 1000 via the DCM 2050 and widen the inter-vehicle distance so that the other vehicles can cut in the widened inter-vehicle distance. One of the plurality of inter-vehicle distances in the caravan 1000 that accepts cutting is, for example, a distance between the vehicle in the caravan 1000 that has detected the blinker and a vehicle driving just behind that vehicle (that has detected the blinker). In widening the distance, the vehicle behind the distance widening position is decelerated. After the distance reaches a predetermined distance y5, the flow proceeds to step S25.

In step S25, the control system 200b determines whether or not the vehicle putting blinker detected in step S21 has cut in the position extended to the distance y5 in step S23, using the rear monitoring camera 2000 and the front monitoring camera 2010. In a case where the control system 200b determines that the vehicle putting blinker has cut into the caravan, the flow proceeds to step S26. On the other hand, in a case where the control system 200b determines that the vehicle putting blinker has not cut in the caravan, step S25 is repeated.

In step S26, the control system 200b determines whether or not the vehicle that cut in the caravan in step S25 has left the caravan 1000, using the rear monitoring camera 2000 and the front monitoring camera 2010. In a case where the control system 200b determines that the cutting vehicle does not exist at the cutting position (in a case where the control system 200b determines that the cutting vehicle has left the caravan), the flow proceeds to step S28. On the other hand, in a case where the control system 200b determines that the vehicle that cut in the caravan is present at the cutting position (in a case where the control system 200b determines that the vehicle that cut in the caravan has not left the caravan), step S26 is repeated.

In step S24, the control system 200b changes the distance between vehicles in the caravan 1000 so that the vehicle determined to be a dangerous vehicle in step S22 cannot cut in the caravan 1000. In this embodiment, the control system 200b changes the predetermined distance (first distance) x1 to a distance (third distance) y6 shorter than the distance xl. For example, the original distance of 10 meters is narrowed to 4 meters. After that distance in the caravan 1000 becomes the distance y6, the flow proceeds to step S27.

In step S27, the control system 200b determines whether or not the vehicle determined to be a dangerous vehicle at step S22 exists within the detection range. At this time, the control system 200b makes a determination based on the images obtained by imaging through the rear monitoring camera 2000 and the front monitoring camera 2010, using the vehicle control unit 2024. In a case where the control system 200b determines that the dangerous vehicle exists within the detection range, step S27 is repeated. On the other hand, in a case where the control system 200b determines that the dangerous vehicle has moved out of the detection range, the flow proceeds to step S28.

In step S28, the control system 200b controls the distance between the leading vehicle and the following vehicle, and the distance between the following vehicles excluding the leading vehicle to the predetermined distance xl. In a case where these distances become the distance xl, the control system 200b terminates the series of operations.

In a case where the control system 200b determines that the speed of the caravan 1000 is lower than a fourth threshold, this embodiment may control the inter-vehicle distance to a fourth distance longer than the first distance (distance xl).

### Other Embodiments

Embodiment(s) of the disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disc (such as a compact disc (CD), digital versatile disc (DVD), or Blu-ray Disc (BD)™), a flash memory device, a memory card, and the like.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

Each embodiment can provide a control apparatus, a control system, a control method, and a storage medium, each of which enables a vehicle driving in a lane next to the caravan to cut in an increased space in the caravan.

This application claims the benefit of Japanese Patent Application No. 2022-164389, filed on Oct. 13, 2022, which is hereby incorporated by reference herein in its entirety.

What is claimed is:

1. A control apparatus configured to control driving of a caravan of vehicles on a same lane by communication, the control apparatus comprising:
a memory storing instructions; and
a processor configured to execute the instructions to:
detect that a target vehicle driving in a lane next to the caravan is putting blinker, and
change at least one distance between the vehicles in the caravan in a case where it is detected that the target vehicle is putting blinker.

2. The control apparatus according to claim 1, wherein the processor is configured to:
acquire position data of at least one of the vehicles in the caravan, and
determine based on the position data whether or not to accept the target vehicle to cut in the caravan, and
stop changing the distance in a case where it is determined to accept the target vehicle to cut in the caravan, even if it is detected that the target vehicle is putting blinker.

3. The control apparatus according to claim 1, wherein the processor is configured to:
control the distance to a first distance in a case where it is not detected that the target vehicle is putting blinker, and
control the distance to a second distance longer than the first distance in a case where it is detected that the target vehicle is putting blinker.

4. The control apparatus according to claim 3, wherein the processor is configured to change the distance from the second distance to the first distance after the processor changes the distance from the first distance to the second distance and determines that the targe vehicle cut in the caravan and then left the caravan.

5. The control apparatus according to claim 1, wherein the processor is configured to change the distance based on a first distance from a last vehicle in the caravan to a vehicle behind the caravan on the same lane.

6. The control apparatus according to claim 1, wherein the processor is configured to change the distance based on a second distance from a leading vehicle in the caravan to a vehicle ahead of the caravan on the same lane.

7. The control apparatus according to claim 1, wherein the processor is configured to change the distance on the same lane so that a distance from a leading vehicle to a last vehicle in the caravan does not change, in a case where the processor determines that a first distance from the last vehicle to a vehicle behind the caravan is within a range of a first threshold, and a second distance from the leading vehicle to a vehicle ahead of the caravan is within a range of a second threshold.

8. The control apparatus according to claim 1, wherein the processor is configured to change the distance on the same lane by accelerating one or more vehicles ahead of a specific vehicle in the caravan in a case where the processor determines that a first distance from a last vehicle to a vehicle behind the caravan is within a range of a first threshold, and a second distance from a leading vehicle to a vehicle ahead of the caravan is not within a range of a second threshold.

9. The control apparatus according to claim 1, wherein the processor is configured to change the distance on the same lane by decelerating one or more vehicles behind a specific vehicle in the caravan in a case where the processor determines that a first distance from a last vehicle to a vehicle behind the caravan is not within a range of a first threshold.

10. The control apparatus according to claim 1, wherein the processor is configured to change the distance based on a speed of the target vehicle.

11. The control apparatus according to claim 3, wherein the processor is configured to:
control the distance to a third distance shorter than the first distance in a case where it is determined that a speed of the target vehicle is lower than a third threshold, and
control the distance to the second distance in a case where it is determined that the speed of the targe vehicle is higher than the third threshold.

12. The control apparatus according to claim 11, wherein the processor is configured to change the distance from the first distance to the third distance, and then changes the distance from the third distance to the first distance in a case where the targe vehicle is not detected.

13. The control apparatus according to claim 1, wherein the processor is configured to change the distance based on a type of the target vehicle.

14. The control apparatus according to claim 1, wherein the processor is configured to control the distance to a fourth distance longer than a first distance in a case where the processor determines that a speed of the caravan is lower than a fourth threshold.

15. The control apparatus according to claim 1, wherein in a case where it is detected that the target vehicle is putting blinker, the processor is configured to control a vehicle ahead of one of the vehicles in the caravan so as to widen a distance between the vehicle ahead of the one and the one.

16. The control apparatus according to claim 1, wherein in a case where it is detected that the target vehicle is putting blinker, the processor is configured to control a vehicle behind one of the vehicles in the caravan so as to widen a distance between the vehicle behind the one and the one.

17. A control system configured to control driving of a caravan of vehicles on a same lane by communication, the control system comprising:
a communication unit configured to perform the communication among the vehicles;
an imaging unit configured to image at least one of a front and a back of the caravan;
a detector configured to detect a target vehicle driving in a lane next to the caravan and putting blinker based on image data acquired from the imaging unit;
a driving unit configured to accelerate or decelerate at least one of the vehicles in the caravan; and
a control unit configured to control at least one distance between the vehicles in the caravan using the driving unit,
wherein the control unit changes the distance in a case where the target vehicle putting blinker is detected.

18. A control method configured to control driving of a caravan of vehicles on a same lane by communication, the control method comprising the steps of:
detecting that a target vehicle driving in a lane next to the caravan is putting blinker, and
changing at least one distance between the vehicles in the caravan in a case where it is detected that the target vehicle is putting blinker.

19. A non-transitory computer-readable storage medium storing a program that causes a computer to execute the control method according to claim 18.
